(19) United States
(12) Patent Application Publication
(10) Pub. No.: US 2024/0367651 A1
(43) Pub. Date: Nov. 7, 2024

(54) METHOD AND DEVICE FOR SELECTING A TARGET OBJECT FOR PERFORMING A FUNCTION OF A DRIVER ASSISTANCE SYSTEM

(71) Applicant: Robert Bosch GmbH, Stuttgart (DE)

(72) Inventors: Alexander Lengsfeld, Bad Muender (DE); Jobst Hoerentrup, Wennigsen (DE); Kamal El Menuawy, Hildesheim (DE); Philip Lenz, Holle (DE)

(21) Appl. No.: 18/629,169

(22) Filed: Apr. 8, 2024

(30) Foreign Application Priority Data
May 4, 2023 (DE) 10 2023 204 128.6

(51) Int. Cl. B60W 30/16; G06V 10/62; G06V 20/56; G06V 20/58

(52) U.S. Cl. CPC B60W 30/16; G06V 10/62; G06V 20/58; G06V 20/588; B60W 2420/403; B60W 2552/53; B60W 2554/80; G06V 2201/07

(57) ABSTRACT

A method for selecting a target object for performing a function of a driver assistance system of an ego vehicle taking into account the target object. Image data of the surroundings of the ego vehicle generated by means of an image sensor are read in. In the method, a selection is made of a foreign object, detected by means of the image data, as a target object, taking into account at least: a first relevance of the foreign object in relation to a lane of the ego vehicle, and a second relevance of the foreign object in relation to a predicted trajectory of the ego vehicle. A device that is configured to carry out the corresponding method, and also to a corresponding computer program are also described.

### CROSS REFERENCE

The present application claims the benefit under 35 U.S.C. § 119 of German Patent Application No. DE 10 2023 204 128.6 filed on May 4, 2023, which is expressly incorporated herein by reference in its entirety.

### FIELD

The present invention relates to a method for selecting a target object for performing a function of a driver assistance system of an ego vehicle taking into account the target object, wherein image data of the surroundings of the ego vehicle generated by means of an image sensor are read in. According to the present invention, in the method, a selection is made of a foreign object, detected by means of the image data, as a target object, taking into account at least: a first relevance of the foreign object in relation to a lane of the ego vehicle, and a second relevance of the foreign object in relation to a predicted trajectory of the ego vehicle. Furthermore, the present invention relates to a device that is configured to carry out the corresponding method, and also to a corresponding computer program.

### BACKGROUND INFORMATION

Current driver assistance systems can include a large number of different functions. For example, adaptive cruise control (ACC) is part of the current generation of driver assistance systems. A typical problem with ACC is the selection of incorrect target objects. Systems which use not only a radar sensor or a combination of radar and video sensors to detect the environment, but operate purely on the basis of video, are increasingly offered here. In the course thereof, image-based environment detection has also been expanded for ACC in the field of situation analysis and ultimately for selecting the target object in the relevant lanes. Here not only the selection of the target object but also the assignment of all objects to the relevant lane can be realized. Further methods operate in three-dimensional space which does not correspond to the native measurement space of a present-day two-dimensional vehicle front camera. Here, the methods mentioned have already shown that, due to errors and ambiguities occurring in a back-projection of the camera data into the three-dimensional space, the present problem can only be solved inadequately.

For example, German Patent Application No. DE 10 2019 208 507 A1 describes a method for determining a degree of overlap of at least one object with at least one lane by means of a representation of an environment of a platform as a two-dimensional pixel data field, comprising the steps of: assigning at least one lane pixel group to pixels of the two-dimensional pixel data field which correspondingly represent at least one lane; assigning at least one object pixel group to pixels of the two-dimensional pixel data field, which correspondingly represent at least one object; defining at least one object pixel pair in the two-dimensional pixel data field which characterizes a width of the at least one object pixel group; comparing the object pixel pair and the lane pixel group in the two-dimensional pixel data field.

In addition, German Patent Application No. DE 10 2006 040 334 A1 describes a method for lane detection using a driver assistance system of a vehicle comprising a sensor system for lane detection. Lane markings of a lane in a region of a traffic area located in front of the vehicle are detected using the sensor system for lane detection. Sampling points having at least coordinates of a first coordinate system are assigned to the lane markings. The coordinates of the sampling points are converted into a second coordinate system. From the position of the sampling points in the second coordinate system, the course of lane markings and/or lanes is reconstructed.

In addition to pure detection problems, such as ghost objects, even in the selection of valid objects that are not relevant in the context of the driving situation, there is also a need for optimization. The latter case is also referred to as secondary lane interference. For example, this is the case if vehicles that only partially fill the ego lane are to be overtaken without changing lanes. These are, for example, motorcyclists or scooter drivers driving on the right-hand lane marking of the ego lane or parked vehicles that only partially project into the ego lane. The desired behavior would be that such objects are not reacted to unless they are relevant in the context, i.e., for example, the ego vehicle is heading toward parked vehicles, or a motorcyclist or scooter driver cannot be overtaken with a sufficient safety distance.

### SUMMARY

The present invention addresses the problem of adapting the target object selection to the driver's intention and, if necessary, overtaking a third-party vehicle in the ego lane. A defined target object can thus be released at an early stage, taking into account collision-free behavior and possibly taking into account applicable legal regulations, or not be selected as a target object at all. Here the driver's intention can be detected independently of other external features such as operating the direction indicator light. Nor is an explicit lane change required in order to detect a driver's intention. According to the present invention, this is made possible by features disclosed herein. Example embodiments of the present invention are disclosed herein.

According to an example embodiment of the present invention, for this purpose, a method is provided for selecting a target object for performing a function of a driver assistance system of an ego vehicle taking into account the target object, wherein image data of the surroundings of the ego vehicle generated by means of an image sensor are read in. According to the present invention, the method is characterized in that a selection is made of a foreign object, detected by means of the image data, as a target object, taking into account at least:
a first relevance of the foreign object in relation to a lane of the ego vehicle, and
a second relevance of the foreign object in relation to a predicted trajectory of the ego vehicle.

For example, an adaptive cruise control (ACC) and/or an emergency braking system (AEB) are to be understood as a driver assistance system. An image (i.e., the image data at a defined point in time) can be ascertained by an image sensor, in particular an optical sensor, such as a camera, a lidar sensor, a radar sensor, an ultrasonic sensor, a time-of-flight sensor or a thermal camera. A combination of these sensors for environment detection is also possible. An image can thus be present in the form of a 2D matrix or a 3D tensor. For example, the image data can be video data of a 2D camera, in particular a two-dimensional video image at a defined point in time. In the case of a combination of sensors, all information is projected into the coordinate system of the camera.

This is understood to mean a method for processing sensor data for a driver assistance system of a vehicle, wherein for the performance of a driver assistance function a foreign object is evaluated and selected as a target object, while taking into account the relevance of the foreign object in the surroundings of the ego vehicle in relation to the lane and also while taking into account the relevance of the object in relation to the predicted trajectory of the ego vehicle. In particular, a spatial assignment of the foreign object to the lane in which the ego vehicle is also currently located is to be understood as the first relevance of the foreign object in relation to a lane of the ego vehicle. In particular, a spatial assignment of the foreign object to the trajectory of the ego vehicle is to be understood as a second relevance of the foreign object in relation to a predicted trajectory of the ego vehicle. A trajectory predicts the future course of the ego vehicle. By means of a trajectory, a future vehicle movement can be displayed, for example, starting from the current vehicle position. The vehicle movement comprises, for example, a driving trajectory and also (for example, over the lane width) a spatial extent of the required driving space within the width. The driving trajectory can be developed from actions initiated for vehicle guidance and correspondingly also comprise an actual driver's intention.

In this understanding, according to an example embodiment of the present invention, a selection is made of a foreign object as a target object, for example a motor scooter ahead of the ego vehicle, for the performance for example of an adjustment of the speed of an ACC, when a first spatial relationship (in particular a defined overlap) is present between the motor scooter and the lane of the ego vehicle and also a second spatial relationship (in particular a defined second overlap or an insufficient distance) is present between the motor scooter and the trajectory of the ego vehicle. In an alternative embodiment, a (pre-) selection of the foreign object as a target object for the driver assistance system can be made on the basis of the first relevance, and the second relevance can serve as (final) selection of the foreign object as (actual) target object. In this understanding, a selection of a foreign object as a possible target object on the basis of the first relevance and possibly a release of a previously selected target object on the basis of the second relevance could be made as soon as it is ascertained that the defined spatial relation required for this purpose in relation to the predicted trajectory of the ego vehicle is not or is no longer given.

In an advantageous embodiment of the present invention, in the method, the first relevance of the foreign object is ascertained taking into account an overlap of the foreign object and the lane of the ego vehicle.

This is understood to mean that a first relevance of the foreign object is ascertained when a defined spatial overlap of the detected foreign object and the lane of the ego vehicle is detected. The method can accordingly comprise further method steps, in particular detection of a foreign object and/or ascertainment of a lane of the ego vehicle. The detection of a foreign object takes place, for example, in a two-dimensional image space, alternatively in a three-dimensional space. In an analogous manner, the lane is ascertained, for example, in a two-dimensional image space, or alternatively in a three-dimensional space.

In one possible embodiment of the present invention, in the method, image data in a native measurement space of the image sensor are used to ascertain the second relevance.

This is understood to mean that the relevance of the foreign object in relation to the predicted trajectory of the ego vehicle takes place in image data in the original measurement space of the image sensor. For example, the use of a two-dimensional camera leads to two-dimensional image data. The second relevance is correspondingly analyzed in a two-dimensional image plane. This means that a spatial relationship between the foreign object and the predicted trajectory of the ego vehicle is analyzed taking 2D data into account. In this case, it is necessary for a trajectory to be defined in a two-dimensional image plane, and also for the foreign object to be present in the two-dimensional image plane.

In a preferred embodiment of the present invention, in the method, in order to ascertain the second relevance: a bounding box is assigned to the foreign object in a native measurement space of the image sensor, and/or the predicted trajectory is defined in a native measurement space of the image sensor.

A bounding box is understood to mean an object frame. This object frame in particular takes the form of a rectangle which encloses the ascertained foreign object. The definition of the bounding box takes place in image data in a native measurement space of the image sensor. For example, the bounding box is defined in a two-dimensional image space, on the basis of a foreign object detected by means of a 2D camera. In an advantageous method step, a foreign object is detected in the native measurement space of the image sensor.

In addition, according to an example embodiment of the present invention, the predicted trajectory is defined in image data in a native measurement space of the image sensor, for example in the case of a 2D camera in a two-dimensional image space. The trajectory is ascertained, for example, on the basis of an expected driving trajectory of the ego vehicle (possibly plus the width of the ego vehicle). In an alternative embodiment, the trajectory is ascertained by means of a projection of the driving corridor of the ego vehicle into the 2D camera plane predicted, for example, with the aid of a vehicle model.

In an alternative development of the present invention, in the method, the second relevance of the foreign object is ascertained, taking into account a geometric variable between a bounding box assigned to the foreign object and the predicted trajectory of the ego vehicle.

This is understood to mean that a geometric variable is taken into account for ascertaining relevance between the foreign object and the predicted trajectory. A spatial relationship between the foreign object and the predicted trajectory is to be described by means of the geometric variable. For example, a distance between the bounding box and the predicted trajectory is evaluated for this purpose. Advantageously, the distance between an object bottom edge (for example the left-hand lower corner) of the object frame and the (for example right-hand) outer boundary of the predicted trajectory is ascertained. The distance can be ascertained in pixels in the image data. The geometric variable can be defined, for example, as a specific ratio of the distance to the width of the trajectory. Alternatively, an absolute value of the distance can also be defined. A conversion of the pixel distance into an actual distance could be made, for example, on the basis of the height position of the measured distance in the full two-dimensional image.

In one possible embodiment of the present invention, in the method, the second relevance of the foreign object is ascertained, taking into account a distance, in particular a horizontal distance, between the bounding box assigned to the foreign object and the predicted trajectory of the ego vehicle.

For example, a distance dimension between the predicted trajectory and the object frame (bounding box) of the ascertained foreign object can be used as a geometric variable. In an advantageous embodiment, the horizontal distance between an object bottom edge (for example the left-hand lower corner) of the object frame and the (for example right-hand) outer boundary of the predicted trajectory is ascertained. In this way, the distance between the foreign object and the ego vehicle as it passes the foreign object is predicted. This makes it possible to reliably estimate whether the ego vehicle can travel past the relevant object at the desired distance. Through the calculation in the projective space of the camera, an estimation can thus also be made at greater distances, a proleptic reaction can be derived, and a final decision can be made with a better signal-to-noise ratio.

In a preferred embodiment of the present invention, in the method, the second relevance of the foreign object is ascertained, taking into account a temporal change in a geometric variable, in particular a temporal change in a horizontal distance, between a bounding box assigned to the foreign object and the predicted trajectory of the ego vehicle.

This is understood to mean that a development of the defined geometric variable is taken into account. For example, the change in the horizontal distance over time is taken into account. This helps to ensure that not only the current situation but also an already initiated change in the situation can be taken into account. A change in the geometric variable, for example in the horizontal distance, can then arise, for example, when the ego vehicle avoids the foreign object, or the foreign object moves independently out of the region of the predicted trajectory.

By incorporating the change in distance, it is therefore also possible to include an intention of the ego vehicle or of its driver (moves to avoid) and possible ego movement of the target object (travels to the side or into the corridor of the ego vehicle) at an early stage, even before the overlap with the lane (ego lane) of the ego vehicle has greater changes. In this way, an earlier reaction in particular to the driver's intention is possible, as long as this cannot yet be recognized, for example, by vehicle odometry (yaw rate, slip angle). If a driver wishes to avoid a parked car, for example, and commences the steering movement, the predicted trajectory projected into the image allows the possible passing to be evaluated quickly even in the case of relatively large distances and, for example, to initially weaken braking toward the parked vehicle and to cancel it completely with increasing safety. Until this behavior were to be clearly reflected in the vehicle odometry, or even an overlap (for example in the two-dimensional image plane) between the target object and the ego-driving lane were represented, significantly more time would pass by in which the ego vehicle would be braked less intuitively by the assistance function.

In an alternative embodiment of the present invention, in the method, the function of the driver assistance system of the ego vehicle is performed in different ways on the basis of the selected target object, taking into account: a context, in particular a driving situation and/or a driving environment and/or a traffic situation, and/or an ascertained object class of the target object; and/or a defined requirement.

This is understood to mean that if the first and second relevances of the foreign object are present, said foreign object will be used as a target object for the driver assistance system, but the specific performance of the function can nevertheless take place differently. For example, legal requirements can diverge in terms of context. For example, a minimum overtaking clearance for cyclists varies depending on the context (for example, urban area as opposed to rural area). Such aspects can advantageously be taken into account and implemented in embodiments of the present invention. For example, depending on the object class (parked vehicle, scooter), different system behavior can also be derived directly in the native measurement space of the camera, so that the functional ACC chain can regulate independently of the sensor.

In an advantageous development of the present invention, an embodiment of the function of the driver assistance system of the ego vehicle is defined on the basis of the selected target object in a native measurement space of the image sensor.

The driver's desire, for example, to overtake a target object in the ego lane can be determined within the sensor, without the need to include unreliable information such as the use of the direction indicator light by the driver. The overtaking intention is detected from measurements in the image space. This also includes the implicit detection of the driver's intention. The use of algorithms in 3D space with noisy back-projection of the camera measurements is not necessary. The overtaking process is detected directly in the projective space of the camera. This method can be implemented, for example, in software or hardware or in a mixed form of software and hardware, for example in a control device. The target object can be deselected depending on a high-level collision check and taking into account legal minimum requirements in order to keep longitudinal guidance active during overtaking according to what the driver wants.

The approach presented here according to the present invention further provides a device which is designed to carry out, actuate or implement the steps of a variant of a method presented here in corresponding apparatuses. The object of the present invention can also be achieved quickly and efficiently by this design variant of the present invention in the form of a device.

In the present case, a device can be understood to be an electrical device that processes sensor signals and, on the basis of these signals, outputs control and/or data signals. The device can have an interface that can be designed as hardware and/or software. In a hardware embodiment, the interfaces can be part of a so-called system ASIC, which comprises a variety of functions of the device. However, it is also possible for the interfaces to be separate integrated circuits or at least partially consist of discrete components. In the case of a software embodiment being used, the interfaces can be software modules that are present, for example, on a microcontroller in addition to other software modules.

The device can therefore be an assistance system for performing emergency braking and/or an adaptive cruise control (ACC) for a motor vehicle, an assistance system for automated control of longitudinal guidance and/or transverse guidance, an environment detection device, in particular a camera, a lidar and/or a radar, a central or decentralized control device which is configured to control one of the aforementioned devices or to carry out the method described. A device can furthermore be understood as a device for outputting information to the driver. Alternatively or additionally, the device can comprise an actuator system for longitudinal control and/or transverse control of the motor vehicle. In a broad interpretation, the device can comprise the overall vehicle.

A computer program product or a computer program having program code that can be stored on a machine-readable carrier or storage medium, such as a semiconductor memory, a hard disk memory, or an optical memory, and that is used for carrying out, implementing, and/or controlling the steps of the method according to one of the embodiments of the present invention described above is advantageous as well, in particular when the program product or program is executed on a computer or a device.

It should be noted that the features listed individually in the description may be combined with one another in any technically useful manner and indicate further embodiments of the present invention. Further features and usefulness of the present invention will be apparent from the description of exemplary embodiments with reference to the figures.

### BRIEF DESCRIPTION OF THE DRAWINGS

FIG. 1 shows a schematic representation of an example embodiment of the present invention.

FIG. 2 shows a representation of an example embodiment of the present invention in a 2D image space.

FIG. 3 shows a representation of the method steps of an example embodiment of the present invention.

### DETAILED DESCRIPTION OF EXAMPLE EMBODIMENTS

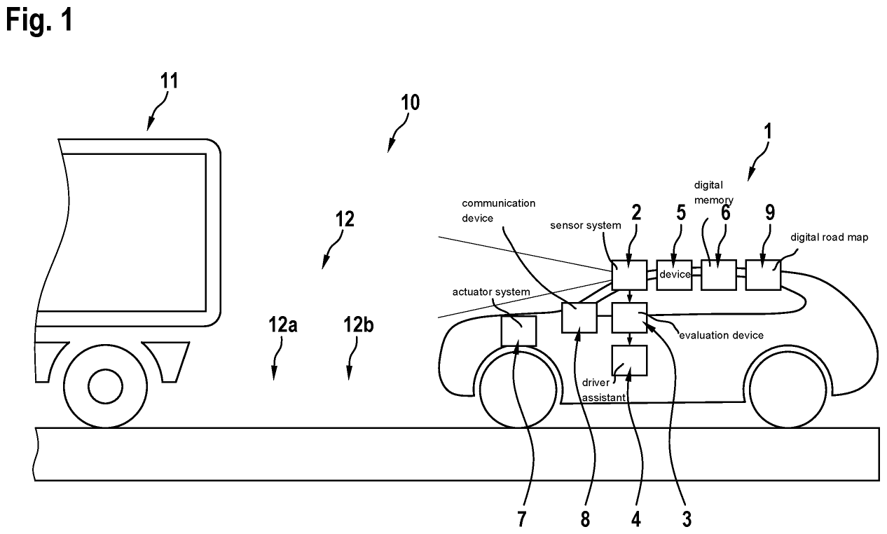

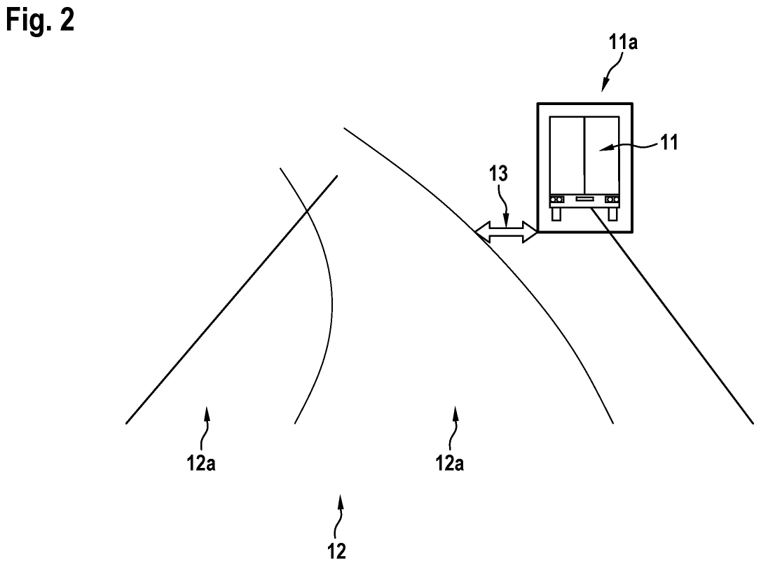

FIG. 1 shows a schematic representation of a first embodiment of the present invention. Shown here is a motor vehicle 1 (also referred to as ego vehicle) in environment 10. The motor vehicle 1 is located in a lane of a roadway 12. In addition a foreign object 11 is—at least partially—located on the roadway 12. The foreign object 11 takes the form of a truck, for example, and is parked at the edge of the roadway 12 in such a way that the left-hand side of the truck is still standing on the roadway 12. FIG. 2 shows a perspective representation of the same situation.

For environment detection the motor vehicle 1 has a sensor system 2 designed as a front camera. By means of the sensor system 2, image data of the environment of the motor vehicle 1 are recorded. These image data are evaluated by an evaluation device 3 (also called a computing unit) by means of evaluation software. In this case, signals are generated and forwarded to the driver assistance system 4 (also called driving assistant).

The driver assistance system 4 can be designed, for example, as an adaptive cruise control. Alternatively or additionally, the driver assistance system 4 can comprise an automated lane-keeping function and a (partially) automated lane-change function and an automated deceleration to standstill function or an emergency stop assistant and/or further functions. The driver assistance system 4 is therefore advantageously designed to control a corresponding actuator system 7 for longitudinal control and/or transverse control of the motor vehicle. Alternatively, the driver assistance system 4 can also comprise such an actuator system.

Furthermore, in the embodiment shown, a device 5 is designed for evaluating the driving situation. However, this device 5 can also be integrated into the evaluation device 3 or into the driver assistance system 4. Of course, integration directly into the sensor system 2 is also possible. Furthermore, a digital memory 6 located in the motor vehicle 1 is shown. A digital road map 9, for example, can be stored in this memory 6.

In the exemplary embodiment shown, the driver assistance system 4 can communicate specific information to the driver by means of a device 8. The device 8 can, for example, be designed as a display and communicate information in a visual way to the driver. Alternatively or additionally, the device 8 can be designed as a loudspeaker, for example, and communicate information to the driver acoustically. In an analogous manner, the device 8 can be designed, for example, as a haptic actuator and can communicate information to the driver, for example by means of steering wheel vibrations and/or seat vibrations.

FIG. 2 shows a representation of an embodiment of the present invention in a 2D image space. This is the same situation as in FIG. 1. However, FIG. 2 shows the situation in a 2D image space, for example the native image space of a monocular front camera of an ego vehicle 1.

As in FIG. 1, a roadway 12 is shown. In addition, a lane 12a is marked (also referred to as a general driving corridor). The lane 12a substantially corresponds to a currently possible driving region of the ego vehicle 1 on the roadway 12. The lane 12a is generally demarcated by a left-hand and a right-hand lane marking. The roadway 12 can furthermore contain a plurality of lanes 12a, but of which only one is shown in FIG. 2. In addition, a predicted trajectory 12b (also called an ego corridor) is drawn in. The course of the predicted trajectory 12b substantially corresponds to a current driving trajectory. The width of the predicted trajectory substantially corresponds to the width of the ego vehicle 1. Accordingly, the predicted trajectory 12b represents a driving region of the ego vehicle 1 on the roadway that is expected to be actually used. The ego corridor 12b generally corresponds to a partial region of the lane 12a.

A foreign object 11 is also shown. This is, for example, a truck in a parking situation in which at least a part of the truck is still standing on the roadway 12 (or on the lane 12a). Furthermore, a lane detection is carried out which has ascertained a current lane 12a. In an analysis of a spatial relationship between the detected foreign object 11 and the ego lane 12a, it can be determined that an overlap is present. Accordingly, there is a first relevance of the foreign object for the ego vehicle 1. The foreign object 11 could be a target object to which the driver assistance system of the ego vehicle 1 would have to adapt, for example, a deceleration of the ego vehicle 1 would have to be undertaken.

However, the method according to the present invention in addition provides the use of a predicted trajectory 12b. This is also shown in FIG. 2. The predicted trajectory 12b is ascertained, for example, from a current driving trajectory. In this way, imminent vehicle movements can be taken into account. FIG. 2 shows a trajectory which extrapolates and continues a leftward steering of the motor vehicle. In addition, a so-called bounding box 11a is defined which encloses the shape of the detected foreign object 11. The bounding box 11a is in turn generated, for example, in the native measurement space of the camera, for example in the 2D image space. A relationship between the actually expected vehicle movement (i.e., the predicted trajectory 12b) and the possibly relevant obstacle (i.e., the detected foreign object 11 or the bounding box 11a) can now be evaluated, for example. For this purpose, a geometric variable 13 (for example a horizontal distance between an object bottom corner of the bounding box 11a and the trajectory 12b) can be ascertained and evaluated. In the example shown, a defined distance is present between the bottom left-hand corner of the bounding box 11a and the trajectory 12b at the same horizontal height. This distance can in turn be compared with legally required regulations (for example minimum distance). Should it be determined as a result that there is a sufficient distance, the detected foreign object 11 can be discarded, for example, as a possible target object for the control of the driver assistance system. This means that there is no adaptation of the ACC speed control nor an initiation of emergency braking, despite the foreign object 11 detected in the ego lane 12a.

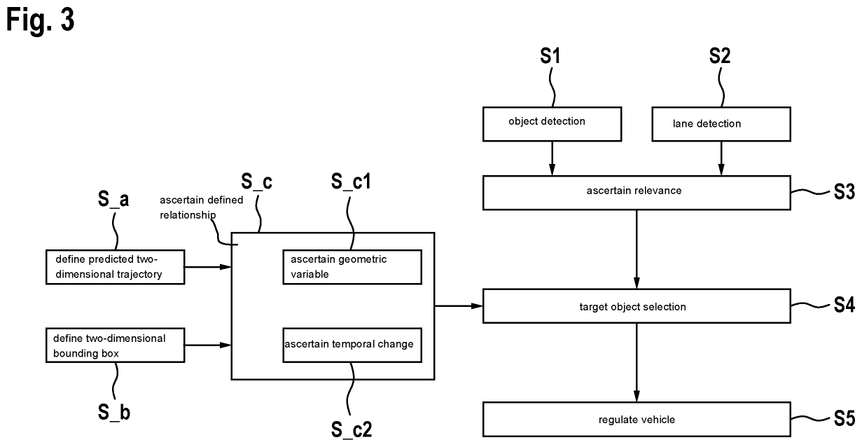

FIG. 3 is a representation of the method steps of an embodiment of the present invention. The method is illustrated on the basis of a flowchart which is intended in particular to show the data flow. Any iterations over the entire method or individual steps are therefore possible. An object detection takes place in step S1. This object detection can take place in a two-dimensional or three-dimensional space. The foreign objects detected are added to the situation analysis and taken into account in step S3. In step S2, the lane is detected. This detection can also take place in a two-dimensional or three-dimensional space.

In step S3, the first relevance of the foreign object is ascertained. The relevance of the foreign objects is ascertained in relation to the ascertained lane of the ego vehicle. Here, an overlap of the foreign object and of the lane of the ego vehicle is ascertained in particular.

A target object selection is made in step S4. The selected target object is then sent with the relevant attributes to the controller and the vehicle is regulated accordingly in step S5. For example, a regulation to a defined target speed and/or a defined distance takes place.

For the final selection of the target object in step S4, at least one further variable is taken into account, namely a second relevance of the foreign object in relation to a predicted trajectory of the ego vehicle. For this purpose, a corresponding predicted two-dimensional trajectory is defined in a step S_a. The definition of the predicted trajectory can be made, for example, in such a way that a driving corridor of the ego vehicle predicted with the aid of a 3D vehicle model is projected into the 2D camera plane. Alternatively, the predicted trajectory can also be defined on the basis of a driving trajectory taking into account the width of the motor vehicle.

In a further step S_b, a two-dimensional bounding box is defined. Such a bounding box marks a detected foreign object. It is in particular designed as a rectangle which completely surrounds the outer contour of the foreign object. On the basis of the trajectory predicted in step S_a and also the bounding box defined in step S_b, a defined relationship between the predicted trajectory and the bounding box is ascertained or checked in a further step S_c. For example, in a step S_c1, a geometric variable, for example a horizontal minimum distance between the two elements in the two-dimensional space, can be ascertained. Alternatively or additionally, in a step S_c2, for example, a temporal change in a geometric variable, for example a temporal change of the first or second order in the horizontal distance between the predicted trajectory and the bounding box can be ascertained or checked.

What is claimed is:

1. A method for selecting a target object for performing a function of a driver assistance system of an ego vehicle taking into account the target object, the method comprising the following steps:
reading in image data of surroundings of the ego vehicle generated using an image sensor; and
selecting a foreign object, detected using the image data, as a target object, taking into account at least:
a first relevance of the foreign object in relation to a lane of the ego vehicle, and
a second relevance of the foreign object in relation to a predicted trajectory of the ego vehicle.

2. The method according to claim 1, wherein the first relevance of the foreign object is ascertained taking into account an overlap of the foreign object and the lane of the ego vehicle.

3. The method according to claim 1, wherein image data in a native measurement space of the image sensor are used to ascertain the second relevance.

4. The method according to claim 1, wherein, to ascertain the second relevance:
a bounding box is assigned to the foreign object in a native measurement space of the image sensor, and/or
the predicted trajectory is defined in a native measurement space of the image sensor.

5. The method according to claim 1, wherein the second relevance of the foreign object is ascertained, taking into account a geometric variable between a bounding box assigned to the foreign object and the predicted trajectory of the ego vehicle.

6. The method according to claim 5, wherein the second relevance of the foreign object is ascertained, taking into account a horizontal distance between the bounding box assigned to the foreign object and the predicted trajectory of the ego vehicle.

7. The method according to claim 1, wherein the second relevance of the foreign object is ascertained, taking into account a temporal change in a horizontal distance between a bounding box assigned to the foreign object and the predicted trajectory of the ego vehicle.

8. The method according to claim 1, wherein the function of the driver assistance system of the ego vehicle is performed based on the selected target object in different ways, taking into account:
(i) a driving situation and/or a driving environment and/or a traffic situation; and/or
(ii) an ascertained object class of the target object; and/or
(iii) a defined requirement.

9. The method according to claim 1, wherein a performance of the function of the driver assistance system of the ego vehicle is defined based on the selected target object in a native measurement space of the image sensor.

10. A device configured to select a target object for performing a function of a driver assistance system of an ego vehicle taking into account the target object, the device configured to:
read in image data of surroundings of the ego vehicle generated using an image sensor; and
select a foreign object, detected using the image data, as a target object, taking into account at least:
a first relevance of the foreign object in relation to a lane of the ego vehicle, and
a second relevance of the foreign object in relation to a predicted trajectory of the ego vehicle.

11. A non-transitory machine-readable storage medium on which is stored a computer program for selecting a target object for performing a function of a driver assistance system of an ego vehicle taking into account the target object, the computer program, when executed by a computer, causing the computer to perform the following steps:
reading in image data of surroundings of the ego vehicle generated using an image sensor; and
selecting a foreign object, detected using the image data, as a target object, taking into account at least:
a first relevance of the foreign object in relation to a lane of the ego vehicle, and
a second relevance of the foreign object in relation to a predicted trajectory of the ego vehicle.
